(19) United States
(12) Patent Application Publication
(10) Pub. No.: US 2013/0110607 A1
(43) Pub. Date: May 2, 2013

(54) COUPON GENERATION, AUTHENTICATION, AND REDEMPTION VIA A NETWORK

(71) Applicants: Steven Allen Basmajian, Coppell, TX (US); Maxim Loukianov, Austin, TX (US); Kinga Margaret Pates, Dallas, TX (US)

(72) Inventors: Steven Allen Basmajian, Coppell, TX (US); Maxim Loukianov, Austin, TX (US); Kinga Margaret Pates, Dallas, TX (US)

(21) Appl. No.: 13/662,530

(22) Filed: Oct. 28, 2012

Related U.S. Application Data
(63) Continuation-in-part of application No. 13/633,760, filed on Oct. 2, 2012.
(60) Provisional application No. 61/554,981, filed on Nov. 3, 2011.
(60) Provisional application No. 61/553,189, filed on Oct. 29, 2011.
(60) Provisional application No. 61/552,461, filed on Oct. 28, 2011.

(51) Int. Cl. G06Q 30/02

(52) U.S. Cl. CPC G06Q 30/0238
USPC 705/14.26; 705/14.38

(57) ABSTRACT

A point-of-sale (POS) and mobile device implemented method of providing customer rebates via machine-readable codes, such as Quick Response (QR) codes. Specifically, a customer completes a transaction at a POS. The POS or remote servers determine if the transaction qualifies for a promotional credit or rebate. If the transaction qualifies for the promotional credit, then the POS generates the QR code, wherein the QR code includes the credit. Further, the customer captures the QR code with a mobile device or scanner and transmits the code to the POS or remote servers for authentication. Upon successful authentication, the POS or remote servers transfer the credit to the customer.

### CROSS REFERENCE TO RELATED APPLICATIONS

This application claims the benefit of U.S. Provisional Application No. 61/554,981 filed on Nov. 3, 2011, which is incorporated herein by reference in its entirety; U.S. Provisional Application No. 61/553,189 filed on Oct. 29, 2011, which is incorporated herein by reference in its entirety; U.S. Provisional Application No. 61/552,461 filed on Oct. 28, 2011, which is incorporated herein by reference in its entirety. This application is a continuation-in-part (CIP) of U.S. Non-provisional application Ser. No. 13/896,141 filed on Oct. 2, 2012, which is incorporated herein by reference, and which further claims the benefit of U.S. Provisional Application No. 61/542,248 filed on Oct. 2, 2011, which is incorporated herein by reference in its entirety

### BACKGROUND

Physical coupons and vouchers that promote discounts are commonly used by merchants, brands and companies to increase and promote sales. Some examples of typical offers from these coupons and vouchers would be 50% off a lunch special or spending $50 on a clothing purchase and receiving $10 off. The coupon or voucher is usually presented and accepted before the transaction is complete to obtain the discounted final price. These coupons or vouchers are usually redeemed at the point of sale through scanning a barcode on the coupon or voucher, through pre-programmed entry or manual entry. Once entered, the transaction amount is updated to reflect the new, discounted transaction amount. These coupons and vouchers may also be used to redeem pre-paid products and services.

Economic or other circumstances entice consumers to seek out coupons and vouchers to obtain a discount on products and services. The current process of using physical forms of vouchers and coupons up-front to obtain a discount is flawed. Many consumers feel embarrassed and hassled from presenting the physical coupon or voucher up-front. Some consumers may forget they have the physical coupon or voucher, negating any benefit or reward. The up-front nature of these types of discounts can create negative experiences for the consumer.

Another drawback of traditional coupons, rebates, discounts, promotions, and sweepstakes is that they typically rely on promotions via printed mediums at a merchant's physical location. While some discounts, coupons, promotions, and sweepstakes may have online components, online participation may be lower than at the physical location. Online promotion and participation of discounts, promotions and sweepstakes may be too expensive for smaller merchants to implement. In addition, the static nature of most discounts, promotions and sweepstakes relegates most merchants to only be able to effectively implement one form of promotion at a time.

Furthermore, machine-readable codes such as QR (Quick Response) codes are often placed in advertisements, retail locations, restaurants and many other consumer related industries. These codes enable consumers to immediately interact and receive information using mobile devices such as wireless mobile phones and tablet computers. Machine-readable codes are typically printed on physical materials making them static and unchangeable. For example, the codes may be for tracking purposes such as shipping boxes, product information stickers at retail stores, provided in print advertising receive more information about a product or service, or at restaurant/retail locations to receive a discount. Printing these codes makes them static and difficult for companies and merchants to target consumers with variable discounts and content. It also makes them difficult to track.

The present invention addresses the limitations thus-far experienced with typical discounts, credit, promotions, coupons, vouchers, and sweepstakes. The present invention allows a customer with to immediate participate in a promotional offer and instantly redeem the associated promotional credit. The present invention also enables merchants to easily and effectively offer a combination of discounts, promotions, coupons, and sweepstakes.

### BRIEF SUMMARY OF THE INVENTION

In one embodiment of the present invention, a method is provided for processing a promotional credit from information contained in machine-readable code. The method further comprising completing a transaction at a point of sale device (POS) and determining if the transaction qualifies for the promotional credit. If the transaction qualifies for the promotional credit, then the POS or a remote server generate the machine-readable code, wherein the machine-readable code includes the promotional credit. Further, a customer captures the machine-readable code with an end device and transmits the machine-readable code to the POS or remote server for authentication. Upon successful authentication of the code, the POS or remote server transfers the promotional credit to the customer associated with the end device.

In another embodiment of the present invention, a system is provided for processing a promotional credit from information contained in machine-readable code, the system comprised of one or more POS devices in communication with one or more servers, wherein the servers are accessible over a network. Further, a printer is provided that is in communication with the one or more POS devices. A mobile computing device is in further communication with the one or more servers, the mobile computing device further capable of capturing the machine-readable code. In addition, the one or more servers are comprised of one or more modules for processing transaction information from the one or more POS devices, generating the machine-readable code, and authenticating the machine-readable code captured by the mobile computing device. In addition, the one or more modules further comprise an authentication module for integrating a digital signature into the machine-readable code, wherein the digital signature comprises one or more public and private keys.

Other advantages, benefits, features, and embodiments of the present invention will become apparent to those skilled in the art upon reading the detailed description of the invention.

### BRIEF DESCRIPTION OF THE DRAWINGS

FIG. 1 illustrates one embodiment of the present invention depicting a point-of-sale device in communication with a central server and the central server in further communication with an end device.

FIG. 2 illustrates one embodiment of the present invention depicting a central server having one or modules and databases for processing receipt data.

FIG. 3 illustrates one embodiment of the present invention depicting a work-flow diagram of the receipt generation and capturing methodology.

FIG. 4 illustrates one embodiment of the present invention depicting a work-flow diagram of digital signature generation and machine-readable code authentication methodology.

FIG. 5 illustrates one embodiment of the present invention depicting a graphical user interface for capturing a machine-readable code and successful code authentication.

FIG. 6 illustrates one embodiment of the present invention depicting a graphical user interface for capturing a machine-readable code and unsuccessful authentication.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “business”, “merchant”, “supplier” or “seller” may be used interchangeably with each other and shall mean any person, entity, distributor system, software and/or hardware that is a provider, broker and/or any other entity in the distribution chain of goods or services and/or that receives payment or other consideration. For example, a merchant may be a grocery store, a retail store, a travel agency, a service provider, an on-line merchant or the like. For example, a supplier may request payment for items sold to a buyer who holds an account with a transaction account issuer.

Phrases and terms similar to a “customer”, “buyer,” and “consumer,” may include any person, entity, software and/or hardware that receives goods or services in exchange for consideration (e.g. financial payment). For example, a buyer may purchase, lease, rent, barter or otherwise obtain goods or services from a supplier or service provider and pay the supplier or service provider using a transaction account.

Phrases and terms similar to “software”, “application”, and “firmware” may include any non-transitory computer readable medium storing thereon a program, which when executed by a computer, causes the computer to perform a method or function.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Phrases and terms similar to “credit”, “rebate”, “campaign”, “coupon”, “sweepstakes”, and “promotion” may include any special offer, discount, credit, donation, voucher, gift card, or any other related promotional items offered by a merchant, business, or supplier to a customer, user, or buyer.

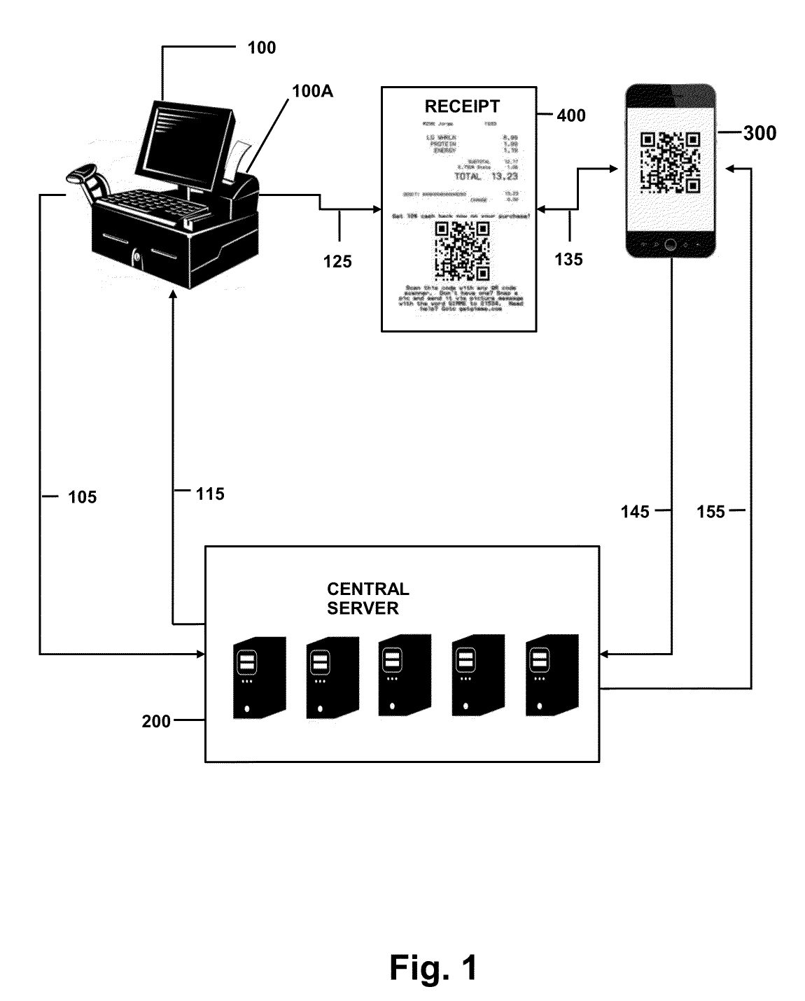

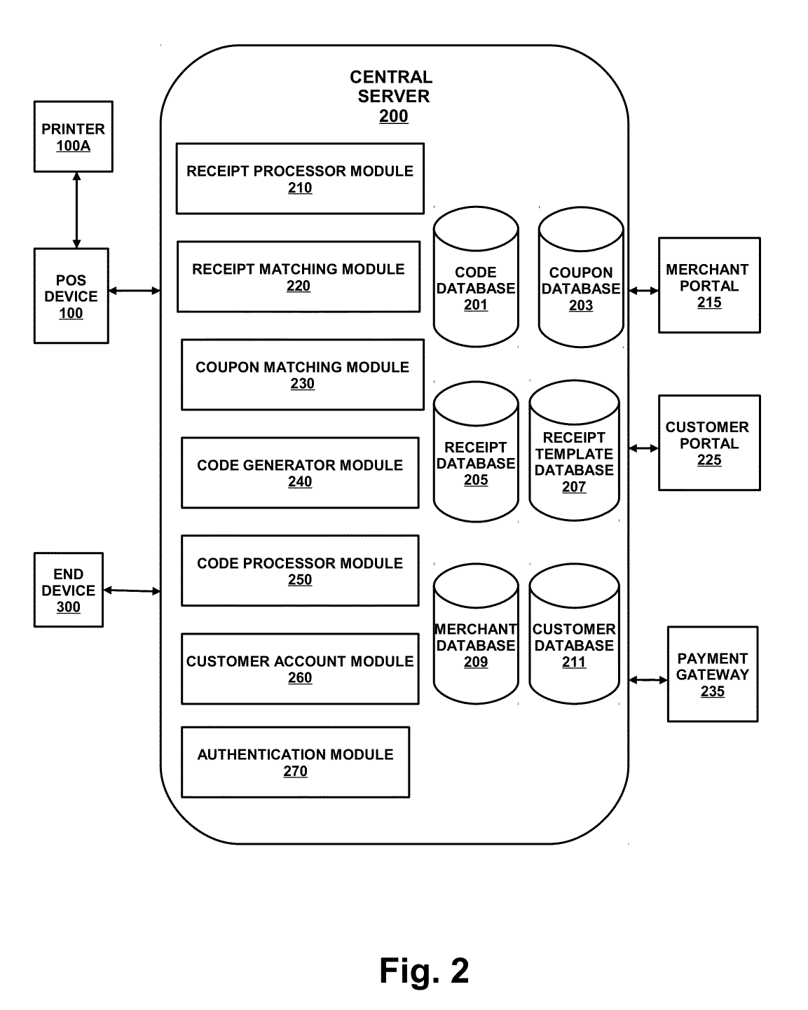

FIG. 1-2 illustrate a diagram of a preferred embodiment of the point-of-sale (POS) and mobile device implemented method of providing customer rebates. The system includes a POS device 100 in communication with a central server 200 and an end device 300 in further communication with server 200. In the exemplary embodiment, server 200 resides remotely from POS 100, wherein POS 100 and server 200 communicate bi-directionally via a network connection. In other embodiments, central server 200 may reside locally on POS 100. In addition, one or more modules 210-270, one or more databases 201-209, or portals 215 or 225 of central server may reside locally or remotely from POS 100. Further, device 300 is capable of communicating with POS 100 directly or via server 200.

POS 100 is typically operated by a merchant of goods and/or services. POS 100 may be any computer-based device having instruction processing capabilities and further facilitating a transaction and further storing customer related information within a database, either locally on POS within its own internal memory or disk storage, or remotely at a central database, such as server 200. POS 100 device may further include any physical terminal or virtual terminal capable of facilitating a financial transaction. POS 100 further communicates with a payment or authorization gateway. POS 100 is further capable of generating a machine readable code, such as one or more unique receipt images, one or more 2-D Quick Response (QR) codes, one or more bar codes, or any other machine readable code or image capable of being encoded with unique data. POS 100 is in further communication with printer 100A for printing on any type of medium, such as paper, one or more unique receipt images, one or more QR codes, or one or more bar codes, or any other machine readable code or image capable of capable of being encoded with unique data. Printer 100A may be a stand-alone printer or integrated with POS 100. In addition, printer 100A may include native or third party software or algorithms for generating and printing machine readable codes, such as QR codes or 1-D bar codes. Further, the one or more machine readable codes may be integrated with a transaction receipt or printed independently of the transaction receipt. POS 100 may further be integrated with a video display for displaying the aforementioned machine-readable codes. POS 100 via server 200, can be further be configured to transmit data corresponding to data encoded in a QR code (e.g., unencoded data or data encoded in a different format) to device 300 using a signal. The signal may be a Wi-Fi or radio frequency (RF) signal, a Bluetooth® signal, an infrared signal, an optical signal, or any other signal now available in the art or which may become available in the future.

End device 300 includes any hardware and/or software capable of sending and receiving data and/or acquiring an image. End device 300 may include a personal digital assistant (“PDA”), a telephone/cell phone, a smart phone, a camera, a peripheral and/or any other device for acquiring and/or sending data. In an embodiment, device 300 may communicate with and/or comprise a peripheral device that include a camera and/or scanner capable of acquiring an image. In the preferred embodiment, device 300 scans a machine-readable code, such as a QR code, using a camera built into the mobile device; that is, the mobile device may take a picture or photograph of the machine readable code. In other embodiments, device 300 may have an independent image or code capturing hardware and/or software.

Referring now to FIG. 2, central server 200 includes a receipt processor module 210, receipt matching module 220, coupon matching module 230, code generator module 240, receipt matching module 250, customer account module 260, authentication module 270, code database 201, coupon database 203, receipt database 205, receipt template database 207, merchant database 209, and customer database 211. In addition, server 200 may be in communication with one or more merchant portal 215, customer portal 225, and payment gateway 235.

Modules 210-270 of FIG. 2 will now be described in further detail. In particular, receipt processor module 210 decodes printer command and/or code language between POS 100 and printer 100A, such as ESC/P, ESC/P2, PCL, and/or PDL other printer languages known to one of ordinary skill in the art. Further, receipt processor module 210 processes the printer commands and provides a generic representation of the printer commands, such as in a token or text form. This generic representation of the receipt is used to find a match within receipt template database 207 with one or more receipt templates. The receipt templates are predefined templates describing various properties to be used for the receipt, such as fonts, sizes, positions, text data, strings, and/or images used to generate a receipt. In one embodiment, the receipt templates assist in transforming the generic representation of the receipt into structured receipt content. In other embodiments, the receipt templates are also used to generate one or more digital signatures. Receipt processor module 210 is further capable of matching receipt data based on prior knowledge of receipt format used at the current printer 110A. Matching can also be performed based on the certain model and software of the POS 100 and/or printer 110A. In addition, receipt processor module 210 can further match one or more sequences of printer commands and text against that same sequence of printer commands and text included in one or more matching receipt templates. Upon finding one or more matches between the generic representation of a receipt with one or more receipt templates, receipt processor 210 generates a set of text elements with tags attached to those elements. These text elements with tags, can include, but are not limited to, one or more of a “Receipt #”, “Table #”, “Waiter”, “Opening time” “Closing time”, “SKU”, “amount”, “unit price”, “price”, “total”, “tax”, “payment method”, and/or any other related parameters.

Receipt matching module 220 will now be described in further detail. In particular, receipt matching module 220 matches the content of the receipt receipt captured by end device 300 with one or more predefined receipts stored in receipt database 205. In one embodiment, module 220 matches a receipt with one or more receipt campaigns currently configured for the POS or printer or merchant location. The coupon matching is done after campaigns have been matched and the best coupon produced according to pre-defined rules and/or conditions.

Customer account module 260 may comprise of any customer identifier data, such as names, telephone numbers, email, code, number, letter, symbol, digital certificate, smart chip, digital signal, analog signal, biometric or other identifier/indicia suitably configured to allow the consumer to access, interact with or communicate with the system. In addition, module 260 may include one or more of an authorization/access codes, passwords, personal identification number (PIN), Internet code, other identification code, and other related security measures that may become available in the future. Further, in other embodiments, module 260 may also include customer profile data, such as purchase history, coupon or credit preferences, coupon or cash redemption preferences, shopping preferences, financial institution data, credit card data, and other information that may pertinent to the system or a merchant. Customer data within module 260 may also be associated with one or more rewards card, charge card, credit card, debit card, prepaid card, telephone card, embossed card, smart card, magnetic stripe card, bar code card, transponder, radio frequency card, or other financial, purchasing, and/or credit methods.

Coupon matching module 230 may comprise of one or more matching algorithms that allow for matching the captured machine-readable code, such as the QR code, with predefined codes in code database 201. In the preferred embodiment, coupon matching module 230 queries codes database 201 for a match with one or more unique QR codes. Code database 201 includes machine-readable codes, such as the QR code, that have associated coupons, credits, advertising campaigns, credit methods, coupon redemption method previously set or predefined by a merchant or seller. In one embodiment, there are two alternative scenarios for which module 230 may match a code with one or more codes in database 201. In one scenario, if there is no connectivity at the time between server 200 and POS 100 or printer 100A, then printer 100A may print the coupon, credit, or transaction data of the QR code on the receipt. In addition, the receipt may be signed by the certificate on that printer. In this scenario, the system allows for the processing that would have happened at the time the receipt is printed to be performed at a later time, after the machine-readable code is captured by the user and the code data transmitted to server 200. In a second scenario, all the data contained in the receipt, including tagged content, is used to reference this data and match it with reference data. This data can represent all the data contained in the receipt, plus the tagged content of the receipt resulting from receipt content being processed with the receipt template. This data is stored on server 200 and the QR code may contains a unique reference to that data. In other embodiments, module 230 may incorporate advanced fuzzy logic algorithms for matching the QR code with predefined QR codes.

Code generator module 240 includes algorithms known in the art for generating and encoding unique machine-readable codes, for example one-dimensional (1-D) or two-dimensional (2-D) bar codes. General bar code generation methods are well known in the art to one of ordinary skill in the art, for example, US 2008/00448044 A1 (Zhao et al.) teaches two-dimensional QR code encoding and decoding and is incorporated herein by reference. However, in the present invention, code generator module is further capable of integrating a digital signature within the QR code. Specifically, the digital signature is used to sign the content of the QR code with a certificate of a known public key. The known public key can be used to verify the authenticity of the content and its creator to make sure this QR code was created by server 200 or POS 100 associated with the merchant and the content of the QR-code has not been modified since being created. Therefore, in case the QR code content can not be verified, the system may not print or display the code; alternatively, the system may print or display the code but alert the merchant that this code is not authentic. Here, the QR code content may be verified using the digital signature at the point where QR code is printed or displayed. In other embodiments, the QR code may be verified at the point where QR-code is scanned and processed.

Still referring to FIG. 2, merchant database 209 comprises various campaigns promotions, sweepstakes, coupons, credits, customer data, and customer purchase history. Further, merchant database 209 may include additional information pertaining to the merchant, such as its financial institution, and other related analytic, tracking, and reporting data.

Code database 201 comprises a collection of one-dimensional or two-dimensional machine readable codes, such as QR codes that are printed on the transaction receipts. Each code is associated with a transaction receipt and references the receipt.

Coupon database 203 comprises of all the promotional coupon data, such as current or prior promotional coupons, credits, promotions as set forth by the merchant or seller. Coupon database 203 may further include the criteria that should be used when selecting the coupon.

Receipt template database 207 is comprised of one or more receipt templates. The receipt templates are predefined templates describing various properties to be used for the receipt, such as fonts, sizes, positions, text data, strings, and/or images used to generate a receipt. In one embodiment, the receipt templates assist in transforming the generic representation of the receipt into structured receipt content. In other embodiments, the receipt templates are also used to generate one or more digital signatures. In other embodiments, receipt templates can be stored on printer 100A or POS 100 internal memory and further processing receipts internally with tagged content being transmitted to server 200. In other embodiments, all the receipt processing is done by printer 100A or POS 100 using instructions downloaded from server 200. This processing may be performed on a routine schedule, such as hourly, once a day, or once a month.

Still referring to FIG. 2, server 200 communicates with a merchant portal 215. Portal 215 allows a merchant to create advertising, coupon, sweepstake, or donation campaigns to be used with the system. Merchant's may set specific rules or conditions for their campaigns, coupons, or credits to be used with the machine-readable codes. They may also set rules or conditions for how a credit may be redeemed or transferred to the customer or the customer's end device 300. Further, portal 215 may allow merchant's to track or monitor coupon's and further provide reporting. Merchant's may also define which machine-readable codes will be used for a particular campaign, coupon, transaction, item, goods, or services. Portal 215 may also provide purchase history, customer behavior tracking, billing, or other merchant related tracking, reporting, or analytics. Merchant's may also link their financial institution to server 200 via portal 215 to automatically credit customers who qualify for credits or cash. Portal 215 may be web integrated with server 200 or a stand-alone software, application, or computer readable medium residing locally on a computing device communication with server 200.

Customer portal 225 allows a customer to create a profile indicating customer preferences. These preferences may include preferred donations, coupons, credits, or rebates, or preferred redemption methods of the coupons, credits, rebates, or donations. The customer preference data can be used by merchant's to further tailor their campaigns, coupons, or credits. The customer profile may also be integrated with one or more social networking systems, such as Facebook®, Twitter®, or Google®. In addition, the customer may link his or her account with their financial institution or credit card for automatic crediting of funds redeemed via the coupon, credit, or cash system of the present invention. The automatic crediting of funds may be performed via Automated Clearing House (ACH) or other known methods in the art.

Referring now to FIG. 1, in the preferred embodiment, as shown by line 105, a customer completes a transaction with a merchant at a POS 100, wherein POS 100 further transmits the transaction information and receipt data to central server 200. Server 200 processes the receipt data and provides one or more machine-readable codes, such as a QR code, and transmits the receipt data including the QR code back to POS 100 at line 115. At line 125, POS 100 via printer 100A, generates and prints receipt 400 including the QR code. At line 135, the customer captures the QR code on receipt 400 via end device 300. At line 145, end device 300 transmits the captured QR code data to server 200. In this embodiment, end device 300 may have optional proprietary or native software having an application programming interface (API) for specifically communicating with server 200 API. The API may incorporate Representational State Transfer (REST) and/or JavaScript Object Notation (JSON). In another embodiment, end device 300 may use its own proprietary or native software or algorithm to decode the captured QR code and open associated URL (Uniform Resource Locator) using the end devices web browser and communicate with server 200 associated web site. Specifically, the system allows users to use a generic QR code reader and a web browser, rather than using a proprietary software. Here, when the QR code is captured by the end device, the QR code reader on the end device extracts the credit, coupon, or promotion from the QR code. The extracted credit information includes a URI (Uniform Resource Identifier), which may be in the form of a URL such as a world wide web address. The URI is used by the generic QR code reader to navigate the web browser of the mobile device to that URI. The URI directs the browser to an application that is operated by central server 200 or other third party providers, which further processes the QR code to provide the coupon, credit, or promotion to the user of the end device. In another embodiment, end device 300 may capture the QR code and transmit the QR code to server 200 as an image using Multimedia Messaging Service (MMS) or Short Messaging Service (SMS). In this embodiment, device 300 may use either long or short code messaging for transmitting the QR code to server 200 for further processing. Furthermore, the MMS or SMS may be sent to server 200 via third party servers and/or gateways.

Still referring to FIG. 1, upon successful transmission of the captured QR code from device 300 to server 200, server 200 processes the captured QR code to determine if the code qualifies for a donation, credit, rebate, or cash redemption. In other embodiments, server 200 may also perform various authentication schemes on the QR code or customer, or both. If server 200 determines that the code qualifies for a donation, credit, rebate, or cash redemption, then server 200 sends a confirmation of the donation, credit, rebate, or cash redemption to device 300 via line 155. In other embodiments, server 200 will automatically credit or donate the amount of funds to the financial institution of the customer either directly or via a third-party payment gateway, such as payment gateway 235 (shown in FIG. 2). In other embodiments, server 200 automatically donates funds to the customers preferred charity. In another embodiment, the customer may redeem the credit, rebate, or cash at the merchant's POS.

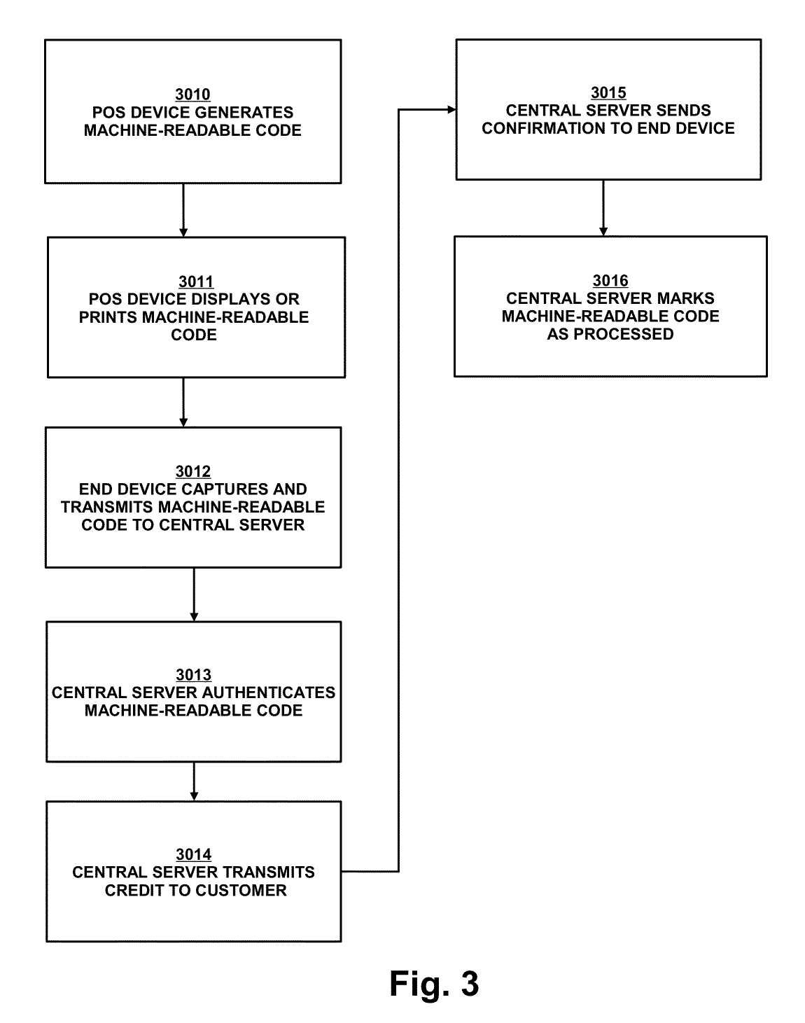

Referring now to FIG. 3, which illustrates another embodiment of the present invention, at step 3010, a customer and merchant complete a transaction and a POS device generates a machine-readable code, such as a QR code. It is contemplated within the scope of the invention that any machine readable code may be incorporated, such as UPC code, RFID code, or an image with unique encoded data. The POS generates the QR code using data stored internally on the POS device, or alternatively data from the POS may be transmitted to a remote server for generating a QR code and transmitting the generated QR code back to the POS. The POS or server may incorporate various algorithms known in the art for generating the QR code. In the exemplary embodiment, only one QR code is generated, however, it is contemplated within the scope of the invention that any number of QR codes may be generated.

At step 3011, the generated QR code is sent to a printer associated with the POS. It is contemplated within the scope of the invention that the printer may be integrated with the POS or may be a stand-alone printer with proprietary software and/or firmware installed for printing the QR code. The QR code is printed on a physical recordable medium, including but not limited to paper, transaction receipts, coupons, or posters.

At step 3012, a consumer captures or scans the QR code using a computing end device, such as a mobile phone, PDA, camera, or machine-readable code scanner. The consumer's end device may scan or acquire the QR code using any technology (e.g., imaging) that is presently available or that may become available in the future. Specifically, however, the consumer's end device may scan the QR code using a camera built into the mobile device; that is, the mobile device may take a picture or photograph of the QR code. In other embodiments, the POS or central server may be configured to transmit data corresponding to data encoded in a QR code (e.g., unencoded data or data encoded in a different format) to mobile device using a signal. The signal may be a Wi-Fi or radio frequency (RF) signal, a Bluetooth® signal, an infrared signal, an optical signal, or any other signal now available in the art or which may become available in the future. In an embodiment, a peripheral in communication with a user's mobile device may take a picture or photograph of the QR code and transmit the QR code or data associated with the QR code to the mobile device. Further at step 3012, the captured QR code is then subsequently transmitted to a central server.

At step 3013, the central server receives the encoded QR code and further decodes and processes the QR code. In other embodiments, the QR coded may be decoded on the end device prior to being sent to the central server. In the exemplary embodiment, the central server verifies the authenticity of the received QR code with stored codes within central server. Further, the central server verifies whether the transaction qualifies for a promotion, credit, rebate, or donation. If authentication of the code is successful, the central server transmits a message to the end device indicating successful authentication. Otherwise, the central server sends a message indicating unsuccessful authentication. In another embodiment, central server may provide an option for the user to either re-scan or re-capture the QR code or terminate authentication event. In another embodiment, the central server may transmit a message to the end device acknowledging or confirming receipt of the captured code prior to code authentication or after code authentication. In other embodiments, the aforementioned messages may be sent to the end device via short messaging service (SMS) or multimedia messaging service (MMS).

At step 3014, if authentication of the QR code is successful, then central server determines whether the QR code qualifies for rebate, discount, credit, discount, donation, and/or promotion. If the QR codes qualifies for a cash or credit rebate, the system will automatically credit the users financial institution with the cash or credit amount. The transfer of cash or credit may also depend on user's preferences indicated in their registered profile associated with the central server. It is contemplated within the scope of the invention that the central server may credit customer's financial institution via third party providers, payment processors, or payment gateways. In other embodiments, central server may mail a check, cash, or other currency to the customer. In other embodiments, the merchant may directly credit the customer in cash or credit at the POS or send the cash or credit to the customer via electronic transfer to their financial institution or mailing the cash, credit, check, or other coupons, rebates, promotions, and/or discounts. In other embodiments, depending on either the merchant's preferences or the customer's preferences, the system can provide alternative rebates, promotions, or discounts in lieu of cash or credit. Further, depending on the merchant's preferences, coupons available, or customer preferences, the central sever may transmit the cash, credit, rebate, discount, promotion, or sweepstakes to the customer's email address. In other embodiments, the central server, via the native application, may provide the customer with a plurality of alternative promotional offers to select from, such as cash, rebate, promotion, other goods, other services, discounts, or related offers. In other embodiments, funds are deposited that originate from one or more parties associated with the central server or third party accounts associated with the operator of the wireless mobile device. In another embodiment, if no customer information is provided within, then the phone number or a unique device identifier of the customer's end device is used to associate the transfer of funds.

At step 3015, the central server sends a confirmation message to the mobile device containing successful confirmation of the fund transfer along with the total amount of funds transferred.

At step 3016, the central server marks the QR code as being processed, thereby preventing the same or substantially similar code to be used or redeemed again.

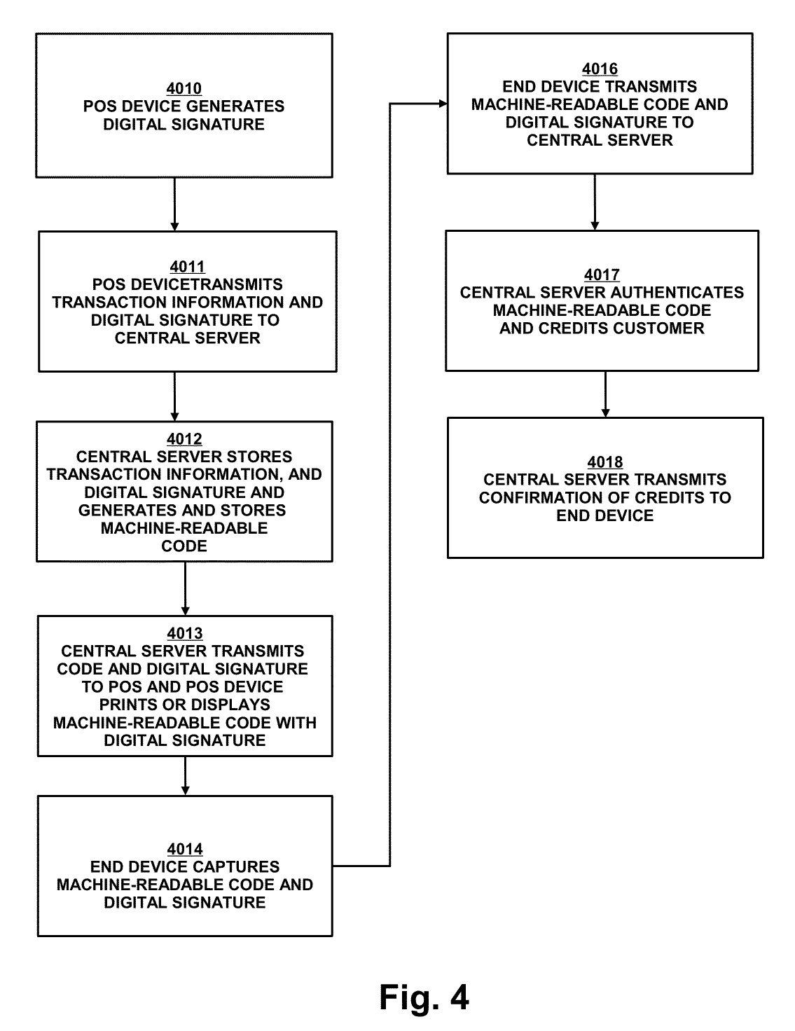

Referring now to FIG. 4, which illustrates another embodiment of the invention, at step 4010, a customer and merchant complete a transaction at a POS device and the POS device generates a digital signature. In other embodiments, POS device may transmit the transaction information to the central server and the central server generates a digital signature. In the exemplary embodiment, a key generator simultaneously generates a public key and private key and stores a private key in a private key storage at the POS or at the central server. The key generator module may incorporate a variety of algorithms to generate the keys, and such private key generators (PKG) and related encryption methods are well known in the art. In one embodiment, the public key is distributed to a signature verification module to verify the authenticity of the digital signature.

At step 4011, the POS device transmits the transaction information and digital signature to the central server. At step 4012, the central server stores the received transaction information and digital signature and further generates and stores a machine-readable code, such as a QR code. The machine-readable code includes the digital signature. At step 4013, the central server transmits the machine-readable code back to the POS device and the POS device further prints or displays the machine-readable with the integrated digital signature. At step 4014, an end device, such as a mobile phone, PDA, camera, with image or machine-readable code capturing technology captures or scans the machine-readable including the integrated digital signature. At step 4016, the end device transmits the captured machine-readable code and digital signature to the central server. At step 4017, the central server authenticates the machine-readable code and upon successful authentication, the central server credits the customer. Finally, at step 4018, the central server transmits confirmation of the customer credit to the end device.

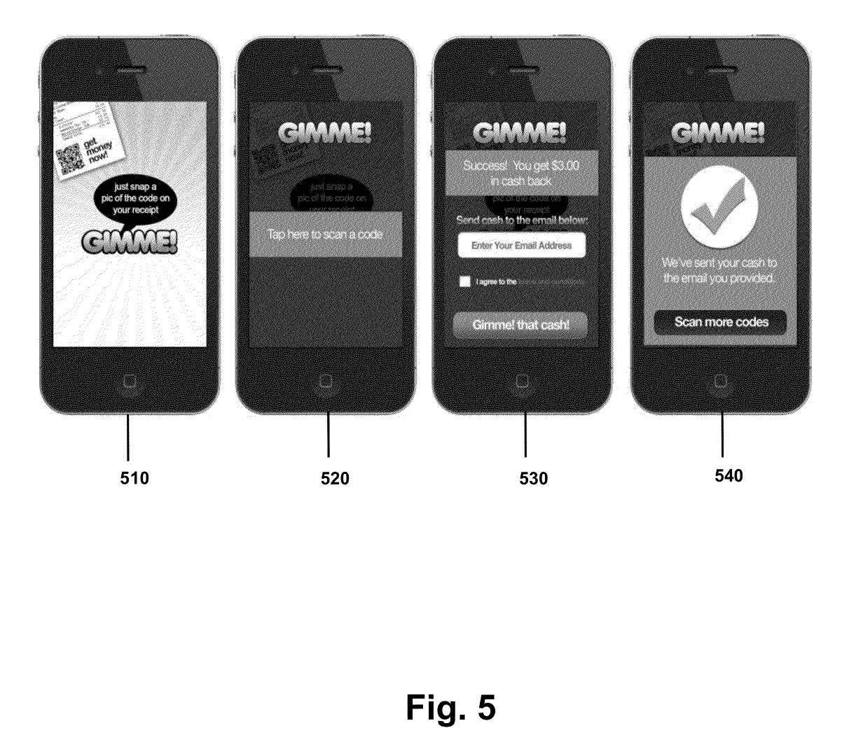

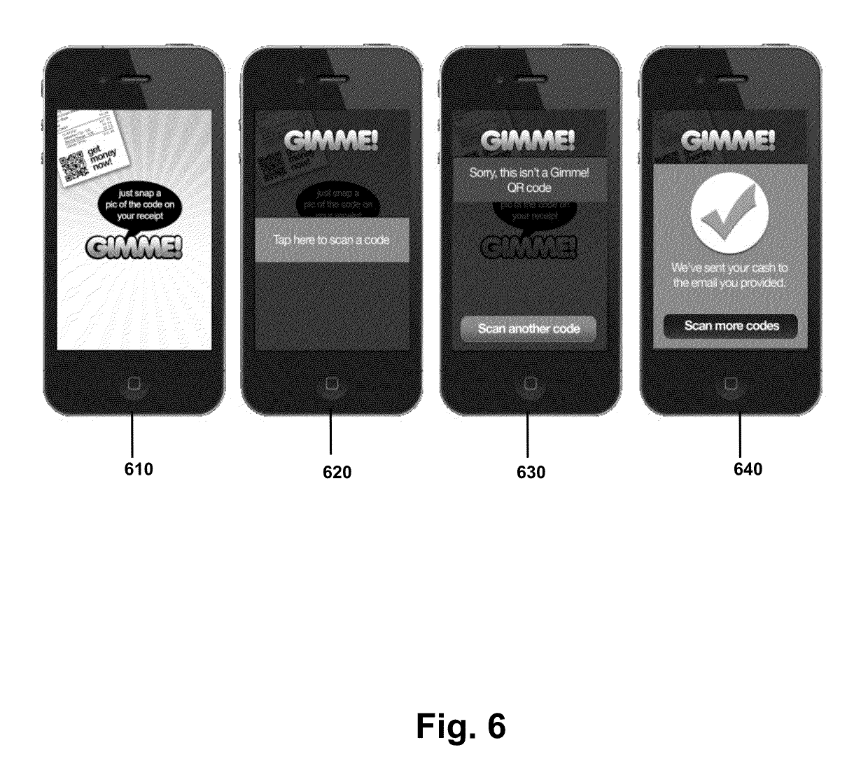

FIG. 5-6 illustrates one embodiment of a graphical user interface (GUI) of an application installed on an end device, such as a mobile phone, PDA, camera, or computing device capable of capturing machine-readable codes in communication with a central server for processing the codes. At steps 510 and 610, a user is presented with the application home screen. At step 520 and 620, the user is prompted to capture a machine-readable code on a printed or displayed receipt, such as a QR code or one-dimensional bar code. The user subsequently taps or selects the screen to capture the machine readable code via the end device. Upon successful capture and authentication of the machine-readable code, the application displays a confirmation message at step 530 showing the amount or type of cash, credit, or rebate. In another embodiment, the GUI may present a plurality of credit, cash, or rebate options for the user to select from. In the exemplary embodiment, the user may enter an email address at this screen to have the system send a link, such as a hyperlink, or alternatively instructions, to the customer to redeem his or her coupon, credit, or cash. The user then taps or selects a redemption icon or button to redeem the coupon, credit, or cash. At step 540, the GUI present a confirmation message to the user indicating that the coupon, credit, or cash redemption hyperlink or instructions were transmitted to the user. In another embodiment, the user may have previously provided his or her financial institution associated with the application for automatic credit or transfer of cash or credit. In other embodiments, upon successful capture and authentication, the user is given the option to select how much cash or credit he or she would like to submit to a preferred charity. The preferred charity may alternatively be designated by the merchant as part of the promotion. The user may submit the selected amount and receive a confirmation screen confirming that the cash or credit was transmitted to the charity. In an alternative embodiment, the system may provide a predetermined amount that will submitted to the charity, wherein the user confirms the submission and is subsequently shown that the transmittal was completed.

Referring to FIG. 6, if the machine-readable code is not successfully authenticated by the application and its associated servers, then the application presents an error or unsuccessful authentication message to the user at 630. The user is then provided the option to scan another code. If the user scans another code and that code is successfully authenticated, then the application will display a confirmation message of the transfer of funds at step 640.

In another embodiment of the present invention, a user may transmit a captured QR code via SMS/MMS to redeem his or her credit, cash, or rebate. In this embodiment, the user takes a picture of the QR code and transmits it to a third party gateway via either a predefined short code or long code. For purposes of illustrating an example of the process, a word such as “GIMME” or short code 21534 may be used, wherein the invention may encompasses the following alternative example scenarios:

(1) For example, if the QR code has already been submitted, user receives message “This code has already been submitted, Go to getgimme.com or Reply HELP for help, STOP to cancel. Msg&Data rates may apply.”

(2) For example, if the QR code is invalid, user receives message “This is not a Gimme! QR code. Go to getgimme.com or Reply HELP for help, STOP to cancel. Msg&Data rates may apply.”

(3) For example, if the QR code is unreadable, user receives message “Code unreadable. Please send a better picture. Go to getgimme.com or Reply HELP for help, STOP to cancel. Msg&Data rates may apply.”

(4) For example, if the second message is unreadable, user receives “Code unreadable. Go to getgimme.com or Reply HELP for help, STOP to cancel. Msg&Data rates may apply.”

(5) For example, if the QR is valid and readable, user receives message “You get $X.XX in cash back. Reply with the word GIMME & your email address. Go to getgimme.com or Reply HELP for help, STOP to cancel. Msg&Data rates may apply”.

(6) For example, if user does not respond within 24 hours, send follow up message, “You're one step away from getting your cash. Reply with the word GIMME & your email address. Reply HELP for help, STOP to cancel. Msg&Data rates may apply”.

(7) For example, if user does not respond to second message, a second follow up message can be sent 2 weeks after the initial reminder message, “You have $X.XX in cash waiting for you. Reply with the word GIMME & your email address. Reply HELP for help, STOP to cancel. Msg&Data rates may apply”.

(8) For example, if user responds with email address and word Gimme, “Success! We sent the cash to the email you provided. Reply HELP for help, STOP to cancel. Msg&Data rates may apply”

(9) For example, if the email address is invalid, send message “The email you provided is invalid. Reply with the word GIMME & a valid email address. Reply HELP for help, STOP to cancel. Msg&Data rates may apply”

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts described herein, except insofar as such limitations are included in the following claims. Further, it will be understood that certain features and sub-combinations are of utility and may be employed without reference to other features and sub-combinations. This is contemplated by and is within the scope of the claims.

What is claimed is:

1. A method of processing a promotional credit from information contained in machine-readable code comprising the steps of:
completing a transaction at a point of sale device;
determining if the transaction qualifies for the promotional credit;
generating the machine-readable code if the transaction qualifies for the credit, wherein the machine-readable code includes the promotional credit;
capturing the machine-readable code with an end device;
transmitting the machine-readable code to one or more servers or the point of sale device for authentication;
authenticating the machine-readable code; and
transferring the credit to a user associated with the end device upon successful authentication of the machine-readable code.

2. The method of claim 1, wherein the promotional credit is one or more of: a coupon, promotion, sweepstake, discount, voucher, cash, or donation.

3. The method of claim 1, further comprising transmitting a confirmation of the credit amount to the end device upon successful authentication.

4. The method of claim 1, further comprising generating a digital signature and integrating the digital signature within the machine-readable code.

5. The method of claim 4, wherein the digital signature comprises a public key and a private key.

6. The method of claim 4, wherein the authentication is performed using the digital signature.

7. The method of claim 1, further comprising storing the credit information on the one or more servers.

8. The method of claim 1, further comprising marking the machine-readable code as being processed thereby preventing a substantially identical code from being used again.

9. The method of claim 1, wherein the machine-readable code is a Quick Response (QR) code.

10. The method of claim 1, further comprising obtaining tracking information from the codes, including one or more of: purchase history, user behavior, and end device properties.

11. The method of claim 1, wherein the end device is comprised of one or more of: a wireless mobile device, scanner, camera, code reader, or personal digital assistant.

12. The method of claim 1, wherein the transmitting is performed via short messaging service (SMS) or multimedia messaging service (MMS).

13. The method of claim 1, wherein the transmitting is performed via a native application on the end device.

14. The method of claim 1, wherein the step of generating the machine-readable code further includes printing the machine-readable code.

15. The method of claim 1, wherein transferring the credit to the user comprises transferring funds to the user's financial institution upon successful authentication of the machine-readable code.

16. The method of claim 1, wherein transferring the credit to the user comprises crediting the user at the point of sale device upon successful authentication of the machine-readable code.

17. The method of claim 1, wherein generating the unique machine-readable code further comprises printing the machine-readable code on a receipt or bill.

18. A system for processing a promotional credit from information contained in machine-readable code, the system comprising:
one or more point of sale devices in communication with the one or more servers, wherein the servers are accessible over a network;
a printer in communication with the one or more point of sale devices;
a mobile computing device in communication with the one or more servers capable of capturing a machine-readable code; and
the one or more servers further comprised of one or more modules for processing transaction information from the one or more point of sale devices, generating the machine-readable code, and authenticating the machine-readable code captured by the mobile computing device.

19. The system of claim 18, wherein the one or more modules further comprise an authentication module for integrating a digital signature into the machine-readable code.

20. The system of claim 19, wherein the digital signature comprises one or more public and private keys.
